(19) United States
(12) Patent Application Publication
(10) Pub. No.: US 2007/0214046 A1
(43) Pub. Date: Sep. 13, 2007

(54) Architecture for information dissemination in wireless mobile ad hoc networks

(76) Inventors: Benjamin Falchuk, Upper Nyack, NY (US); Abdelhakim Hafid, Laval (CA); Narayanan Natarajan, Marlboro, NJ (US)

Correspondence Address: TELCORDIA TECHNOLOGIES, INC., ONE TELCORDIA DRIVE 5G116, PISCATAWAY, NJ, 08854-4157, US

(21) Appl. No.: 11/709,069

(22) Filed: Feb. 21, 2007

Related U.S. Application Data
(60) Provisional application No. 60/775,153, filed on Feb. 21, 2006.

(51) Int. Cl. G07G 1/14; G06F 17/00

(52) U.S. Cl. 705/14

(57) ABSTRACT

In future large-scale Emergency Response/Management (ER/EM) to terrorism and natural disasters, sharing the so-called common operational picture amongst dynamic task groups provides immediate advantages. In an ER/EM scenario, dissemination of the right data to the right person at the right time has a direct benefit. Timely and bandwidth efficient dissemination of sensor and Command and Control data remains a challenge. For example, dynamically changing mobile teams, information-needs profiling, information routing based upon information needs (not on IP address) are all complex issues. Accordingly, a protocol, called dissemination mesh, for constructing and reconfiguring network paths for disseminating information from sources to sinks, a software architecture for multi-domain wireless network information dissemination in the context of emergency response (resting above existing MANET protocols), supports needs-based dissemination, node mobility, rapidly changing groups (information sinks) and sensor networks (sources) is provided. The protocol includes: exploitation of Semantic Web and collaborative agent technologies, novel subscription-based information dissemination, intelligent networked information intermediaries, smart dissemination mesh forming and management. Together these technologies provide information dissemination management in the wireless setting. Application realms other than ER/EM can also be supported.

### CROSS-REFERENCE TO RELATED APPLICATIONS

This application claims the benefit of the filing date of U.S. Provisional Patent Application No. 60/775,153, filed Feb. 21, 2006, the disclosure of which is hereby incorporated herein by reference.

### FIELD OF THE INVENTION

The present invention concerns information management and delivery upon peer to peer and mobile ad hoc networks of various kinds. It has several useful applications including corporate, banking, and emergency management. More generally, the invention provides novel and efficient mechanisms to help ensure that valuable network resources are used efficiently while directing information flow between network nodes and users.

### BACKGROUND OF THE INVENTION

Wireless dissemination of information is desirable in both military and civilian realms. For example, in future network centric urban warfare, information superiority demands the dissemination of relevant data to the right person at the right time, thereby enabling a common operational picture amongst the dynamically established task groups. Timeliness and bandwidth-efficiency are two key aspects. In such a scenario the disseminated information may include: targeting data, temperature data, maps, satellite imagery, seismic or motion sensor data, etc., and a main concern is the routing of relevant sensor data from its source, across wireless networks, to an information sink (e.g., a human user or computer system whose information needs have been gathered or profiled). This is challenging for many reasons including:

Information sinks are highly mobile; sinks requiring similar information are not necessarily in close proximity, nor can they necessarily be addressed by a static network address.

Intermediary routing nodes may be destroyed, damaged, or moved.

Wireless equipment has innate power constraints.

Task-group members change dynamically and rapidly.

Alternatively (but with similar challenges), civilian and government emergency response institutions such as Fire, Police and EMS, now have access to sophisticated wireless and sensor equipment and technologies, making possible wireless Emergency Operations Centers (EOC). Wireless communications are a key part of the Department of Homeland Security's National Incident Management System. ‘Standard’ incident organizational protocols like Incident Command System (ICS) depend upon efficient lateral (e.g. between responders) and hierarchical (between responders and Incident Commanders) information flow; such flows are facilitated by wireless infrastructures. For example, although New York's EOC was actually destroyed by the Tower collapses during the 9-11 attacks, on-site wireless command posts (on rugged laptops) played a key role during subsequent recovery efforts, allowing on-site personnel to wirelessly enter equipment needs which would be replicated onto servers at the EOC at Pier 92. Even though during 9-11 the emergency bands were overwhelmed, a concern is that simply over-provisioning new bands could actually compromise emergency Command-and-Control by enabling too much chatter. Approaches are needed to better manage the aggregation, filtering, and dissemination of information from important sources to the sinks that require it.

Much as in warfare, in future large-scale emergency response (ER) to terrorism and natural disasters, sharing the so-called common operational picture amongst dynamic task groups provides immediate advantages. In the emergency response scenario, dissemination of the right data to the right person at the right time has a direct benefit: the preservation of human lives. In any case, timely and bandwidth efficient dissemination of sensor and Command and Control (C2) data remains a challenge. For example, dynamically changing mobile teams, information-needs profiling, information routing based upon information needs (not IP address) are all complex issues. The invention focuses on a software architecture for wireless network information dissemination in the context of emergency response. The architecture (resting above existing MANET protocols) supports needs-based dissemination, node mobility, rapidly changing groups (information sinks) and sensor networks (sources) is unique and promising.

A mobile ad-hoc network (also known as a MANET) is a self-configuring network of mobile routers (and associated hosts) connected by wireless links—the union of which form an arbitrary topology. The routers are free to move randomly and organize themselves arbitrarily; thus, the network's wireless topology may change rapidly and unpredictably. Such a network may operate in a standalone fashion, or may be connected to the larger Internet. Minimal configuration and quick deployment make ad hoc networks suitable for emergency situations, military conflicts, homeland security and the like. Their adaptability to change and survivability make MANETs relevant in many other realms. Peer-to-peer computing (P2P) applications are those in which participating devices have relatively equal responsibilities, though those may change over time. Traditionally, devices play the role of either client (requiring information) or server (serving information). In P2P applications, devices (and their users) are sometimes clients and sometimes servers and no one system is considered a central repository. Servers, access to (and retrieval of) the device's stored information is initiated by another device, (often transparently), when clients, devices disseminate information requests to other peers. Multiple copies of information may be stored amongst the P2P peers. Napster and Gnutella are two well-known P2P applications that enable P2P file sharing. P2P is relevant at the OSI layer 7 (application-layer) whereas MANET technology rests at layers 2 and 3.

Note that mobility and efficiency are tied together. As mobile responders move between network domains it becomes paramount to also reroute their information paths so as not to waste valuable computing or network resources.

Prior efforts to solve the problem of information dissemination in wireless emergency management include GIS-based emergency management systems such as ETeam described in “E Team, Collaborative Software for Government” at http://www.eteam.com/government/index.html, EM/2000 described in EMIS Technologies Inc., EM/2000 Software, found at http://www.emistech.com, and Solers Inc. (http://www.solers.com)) present incident maps, cross reference city and industrial data (population densities, etc.) and enable information workflows that are selectively available to all responders via standard Web protocols. However, these products do not disseminate through multi-domain networks from source to sink nor do they support wireless ad hoc mobility.

Agent-based approaches to military and civilian are well-studied. For example, Operation Iraqi Freedom utilized the U.S. Army's agent-based ICODES system for ship loading, in which interacting agents that understand different aspects of the task (e.g. cargo placement), make recommendations and evaluate alternatives in real-time. However, no systems that we are aware of use agents as a fundamental part of sensor data query aggregation and routing. An article by H. Chalupsky, Y. Gil, C. Knoblock, K. Lerman, J. Oh, V. Pynadath, T. Russ, M. Tambe, entitled “Electric Elves: Applying agent technology to support Human Organizations”, in Proc. Int'l. Conf. Innovative Appls. Of AI, Seattle, August, 2001 is concerned with the ‘adjustable autonomy’ of agents managing enterprise applications but does not describe an agent approach to needs aggregation. An article by H. Qi, S. Iyengar, K. Chakrabarty,entitled “Multiresolution Data Integration using Mobile Agents in Distributed Sensor Networks”, in IEEE Trans. On Systems, Man, and Cybernetics—Part C: Appl. And Reviews, 31(3), 2001, 383-392 models effectiveness of agent mobility in sensor data integration but no approach to information models or inter-agent interactions is described. While the present invention will not require new agent platforms (e.g. it is possible to exploit existing ones), our ontologies capture concepts of collaboration and queries in such a way as to enable agent-based inference and value-adding automation.

Application and Group context is not well exploited in multicast or peer-to-peer approaches—even geographical ‘proximity’ goes largely unexploited in querying file-sharing systems. For example, in H. Chalupsky supra, inference from context is not applied. In M. Bowman, A. Lopez, G. Tecuci, Ontology Development for Military Applications, Proc. 39^{th} Annual ACM Southeast Conf., March 2001, 112-121, military ontology design tools are discussed but few existing agent systems in the dissemination domain exploit ontology-based inference. In the present approach, internal Dissemination Server components understand the fundamental notions of the sensor networks, user needs and context. The result is a dissemination paradigm that better takes into account users' implicit context.

Related P2P approaches have some similarity to this invention. However some key differentiators are:
Several main P2P systems are primarily server-based (e.g. Napster). This means that the clients wanting shared content connect first to one of several (there are often tens of options) servers. The client then issues a query to that server who resolves the required content to a list of possible sources. This is not the case in the proposed invention in that there is no “main” server or single point of failure.
Once neighboring nodes are discovered, nodes in P2P systems generally open (and keep open) network connections to all such peers. Such an approach is not feasible in ad hoc networks where a fixed link to a neighbor cannot be assumed, peers are likely to move, and scarce network resources need to be conserved.
P2P servers resolve sources of data exclusively to IP addresses. This is not the case in the proposed invention in which sources of information do not have static IP addresses.
P2P users generally know the name of the media that they desire in advance—not the case in our invention context.

The novelty of the present invention resides in the fact that:
it is sensitive to failures of individual nodes at any time during delivery.
it delivers information continuously and efficiently (i.e. does not create more information flows than necessary); a timer-based query propagation method saves bandwidth over known hand-shake and other 3-way approaches.
it supports dissemination to mobile devices allowing information “sinks” and “sources” to move with minimal disruption to information flow.
it supports the formation of a logical information mesh that associates information flows from sources in the direction of sinks with matching information needs.
it supports the formation of teams of peers (who share information needs) and efficient dissemination to members of teams, even as teams structures change.
it supports information delivery based on content subscription (e.g., expressions of information needs) rather than network-level address—information needs may be explicitly specified, or, inferred (in whole or in part) from some situational context
it supports embedding of information delivery capability into all devices. From the information level, the devices form an overlay network of “dissemination servers”.

Existing dissemination systems often rely on dissemination servers deployed in fixed operations centers. In the present approach, dissemination capabilities are embedded in the nodes in all domains of the network, and nodes assume intermediary roles in a dynamic manner as part of mesh construction. This not only enables responders to move around without being tied to fixed operations centers, but also enables scalability and survivability. In addition, the servers stream information constantly (when required) to sinks, and, unlike network or application multicast described in J. Liebeherr, M. Nahas, and W. Si, Application-Layer Multicast with Delaunay Triangulations, Technical Report CS-2001-26, Univ. Virginia, November 2001, do not rely on source and destination addresses; instead, dissemination is based purely on information needs.

### SUMMARY OF THE INVENTION

The problem being solved is to devise a dissemination scheme that allows information delivery across peers on MANET networks, in P2P style, such that information flows continuously (based on the needs of the sink) from source to sink. The flow may cross several intermediary nodes that must each forward the information on towards the sink. Meanwhile, the topology of the MANET may change and intermediaries may disappear, while network resources may be scarce and their utilization minimized.

The benefits of effective information dissemination management (IDM) depend on the realm of the application:
in a financial realm, IDM enables time-sensitive trading information on which profit will depend.
in emergency management context, effective IDM saves human lives.
in military context, IDM helps achieve tactical goals and maintain superiority over enemies.

The underlying network nodes are not constrained to a certain type so long as some can be categorized as information sources, others as sinks, and others as intermediaries capable of playing an active role in information dissemination. Therefore, the following network deployments are achievable:
sensor networks (mix of sensor nodes and computing platforms).
wireless networks such as for emergency management, military, search and rescue, etc. (mix of hand-held and laptop and desktop computers).
medical and hospital wireless networks (mix of mobile doctor devices and fixed devices)
networks, each of whose sub-domains have independent properties.

Developing such an approach requires considerations that:
devices may be mobile, crossing into new sub-networks, while information delivery needs to be maintained.
devices requiring similar information are not necessarily in close proximity, nor can they necessarily be addressed by a static network address.
intermediary routing nodes may be destroyed, damaged, or moved.
wireless equipment has innate power constraints.
although logical groups often constitute shared interests (and information), members of groups change dynamically and rapidly and members may not be in close proximity.

The present invention addresses these main challenges related to wireless ad hoc emergency response with:
Efficient use of limited network bandwidth.
Timely and continuous dissemination of information to mobile Responders and C2 applications without requiring them to be tightly coupled with fixed operations centers.
Enable emergency response ‘on the move’.
Enable information sharing among different echelons of Incident Command.
Information dissemination systems must survive loss of nodes and adapt to emergency conditions.

The present invention's Agent-based architecture represents a novel and effective software architecture that groups and embodies system functionality into distinct and semi-autonomous processes (running in software or on silicon). The present invention can be considered ‘intelligent’ in the sense that a) information is routed based on needs, not network addresses, and b) information may be transformed at any intermediary node. It exploits agent and semantic Web technology. Agent-based systems have been shown to be effective when there is no centralized control, and where flexible collaboration is desired between components.

In order to best understand the present invention it is necessary to first define certain terms:
Information Source/Sink—any node generating data (usually continually) and emitting onto the MANET is a source. Any node expressing an information need is a sink. A given node can play one, both or neither roles at any time.
Information Need/Information Subscription—a canonical expression of information requirement understood by Dissemination Server
Dissemination Server (DS)—an intermediary role that a device on the MANET can play. Several deployment variations exist for successively more capable operating systems: lightweight, middle-weight, and full.
Dissemination Mesh—a logical interconnectivity between information sources and sinks along which information can be disseminated. Includes one or more Dissemination Servers.
Responder/User—any person with information needs and reachable via the wireless network via a computing device e.g. Fireman, Emergency, Police, Incident Commander, HAZMAT, structural engineers, doctors, etc. Also referred to as ‘information sinks’. Users carry wireless communication devices.
Dynamic Collaborative Group (CG)—a constantly changing assignment of responders to mission tasks. Group members share at least one common information need.

While the invention is depicted in the realm of emergency management, the invention is not so limited to only that domain.

The present invention will be best understood when the following description is read in conjunction with the accompanying drawings.

### BRIEF DESCRIPTION OF THE DRAWINGS

FIG. 1 illustrates a deployment and usage of the invention for mobile Responders using MANET technology at an emergency incident site.

FIG. 2 illustrates the DS behavior during query processing.

FIGS. 3a-3d show the construction of a mesh initiated by Sink1.

FIGS. 4a-4b show the reconfiguration of a mesh.

FIGS. 5A-5D illustrate DS interactions in supporting collaboration groups in an ad-hoc network that comprises four domains when a node roams outside of its domain to a new domain; each domain having its own DS.

FIG. 6 shows system management when a node roams outside of its domain to a new domain and its IP address changes.

FIG. 7 shows system management when a DS roams outside of its domain to a new domain and it gets a new IP address (from DRCP).

FIG. 8 shows continuous dissemination of information to and from mobile nodes in an emergency response scenario.

FIG. 9 illustrates a deployment and functional architecture for DSs and clients on a MANET.

FIG. 10 shows Dissemination Agents executed in the DS provisioned and assigned to one of three possible roles.

FIG. 11 shows agent-based collaboration and aggregation.

### DETAILED DESCRIPTION

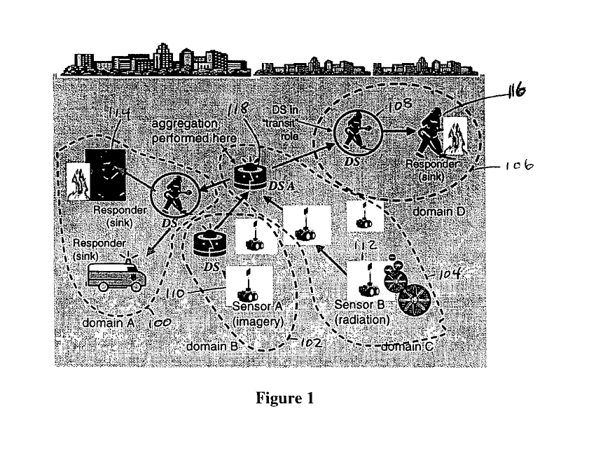

FIG. 1 illustrates a deployment and usage of the invention for mobile Emergency Responders using MANET technology at an emergency incident site (e.g., a large fire in an urban setting). In the figure, the sources, sinks, and intermediaries are noted; dashed areas represent network sub-domains 100,102,104,106. The networked devices of human Responders may be used as intermediaries in a Mesh and this may occur completely or partially transparently to the human user of the device. This is the case with the Responder 108 in FIG. 1 who is a “DS in ‘transit’ role”.

Architecturally, the self-forming capabilities of ad-hoc networks are leveraged. An ad-hoc network is organized into domains that are interconnected using border nodes; a domain is a multi-hop subnet. Each domain comprises a number of nodes that may move freely from one domain to another domain. In this multi-domain environment there are one or more, plus backups, Dissemination Server (DS) in each domain. Any node in the domain may perform the DS role by implementing DS protocols. Initially, the DS can be selected using an election protocol executed by the domain's nodes or the DS can be selected based on the pre-configured capabilities of nodes (e.g., ability and willingness to be a DS).

A DS learns about its neighboring DSs via border nodes. A border node belongs to more than one network domain, and the border node knows the address of the DS in each of the domains. The border node obtains these addresses as part of node auto configuration that occurs when the node joins a network domain. The dissemination mesh protocol will be used by DSs in different domains to configure meshes to support the interests of the nodes in the different domains. Communication between the nodes and their DSs and among DSs can use any underlying routing and transport layer protocols (e.g., AODV, TCP). No assumptions are made regarding the underlying network and link protocols. If the network nodes support differentiated services (diffServ) model then data, disseminated in the network, will receive a treatment at the node level commensurate with their service class. In the invention, data marking (i.e., setting diffServ Code Point—DSCP) is performed by data sources.

The invention is based on the following principles: (a) content and query based routing: dissemination paths between sources and sinks are computed based on the interests specified by the sinks and the data that the nodes provide either directly as sources or indirectly as intermediaries; (b) filtering and aggregation: nodes use filtering and aggregation to pre-process and minimize the quantity of data sent towards the sinks; (c) redundancy: disseminating one or more duplicates of each data to improve the delivery reliability. The approach comprises constructing a dissemination mesh between the sinks and the sources; the dissemination mesh is reduced to a tree when only a single sink and multiple sources are involved. After the dissemination mesh is constructed, sources send data towards the sinks using the mesh. Nodes in the mesh may manipulate the information (e.g., filter, aggregate, etc.) before forwarding the data towards the sinks. Nodes in a network domain communicate with the domain's DS to specify their interest in (a) joining a collaboration session; (b) starting a collaboration session; (c) leaving a collaboration session; (d) getting data of interest to them; and (e) providing data to other nodes that are interested.

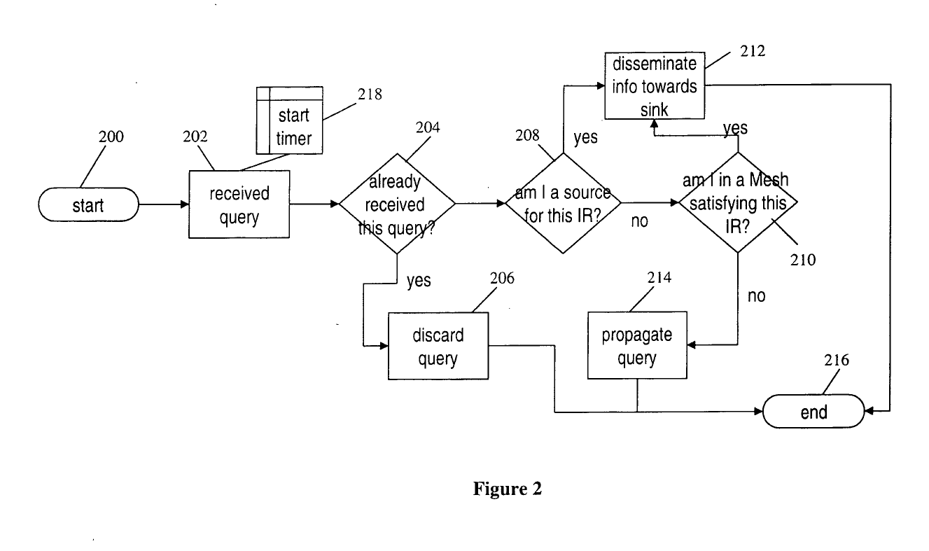

FIG. 2 illustrates the DS behavior during query processing. The query process starts 200. A node receives a query 202. If the node has already received the same query 204 (e.g., from a different neighbor), then the node discards the query 206; otherwise, the node propagates the query to its neighbors 208. If the node is a source 208 (i.e., a node/sensor that senses the requested data) or is already a member of a mesh that disseminates the information that satisfy the query 210, the node terminates the propagation of the query and starts forwarding the information toward the sink 212. If the node is not of the mesh, the query propagates 214 and then the information is forwarded toward the sink 212. FIG. 1 shows a dissemination mesh that disseminates data from two sensors 110,112 to two sinks 114,116 that have similar interests in receiving data from the two sensors. Aggregation of data is performed by DS A 118 and delivered to the users/sinks.

One of the key features of the proposed mesh protocol is its efficiency in using the network resources. Queries are propagated only when necessary; after a mesh is constructed. Data flows efficiently from sources to sinks. Overhead, in terms of state information kept by the nodes and messages exchanged to construct meshes, is minimized. Individual DSs may use any of the following considerations when deciding whether to take part in a Mesh:

energy required to disseminate the information in question (the query or a payload).

computing resources required to disseminate the information in question.

estimation of temporal factors (est. availability/up-time of the node or the Mesh).

Two protocol mechanisms help minimize the use of valuable (sometimes scarce) network resources:

1) Timer-based Approach to limit bandwidth usage—Each node that forwards a query to a neighbor waits for a predefined period of time 218 to receive the corresponding response. If it does not receive the response within this time period, it removes the entry for the original query qi (i.e., it is no longer part of the mesh related to qi). The timer-based approach allows for a highly efficient use of scarce network bandwidth (and energy power) since it does not require exchanges of Ack/Nack messages to construct meshes. It is a one-way approach from sinks to sources to construct meshes (compared, for example, to the three-way handshake found in the prior art).

2) Hop-based options for bandwidth conservation—A sink propagates a query with a hop limit equal to m. A node that receives the query and decides to propagate the query decrements the hop limit. If a node receives the query with a hop limit equal 1, it discards the query. The sink waits for a period of time to receive the corresponding response to its query. If the sink does not receive data within this time period, the sink propagates the query with a hop limit equal to m+1. This process can be repeated until the sink succeeds getting the requested data or after some predetermined period of time. This approach saves a considerable amount of network resources.

In addition, in order to allow the favoring of specific meshes between sources and sinks (and canceling those same meshes) the protocol enables two distinct types of messages:

Enforce—used to enforce the association between a sink and the neighbor it considers the best (e.g. has best quality or shortest response time)

Cancel (un-enforce)—used to un-enforce a previous enforcement

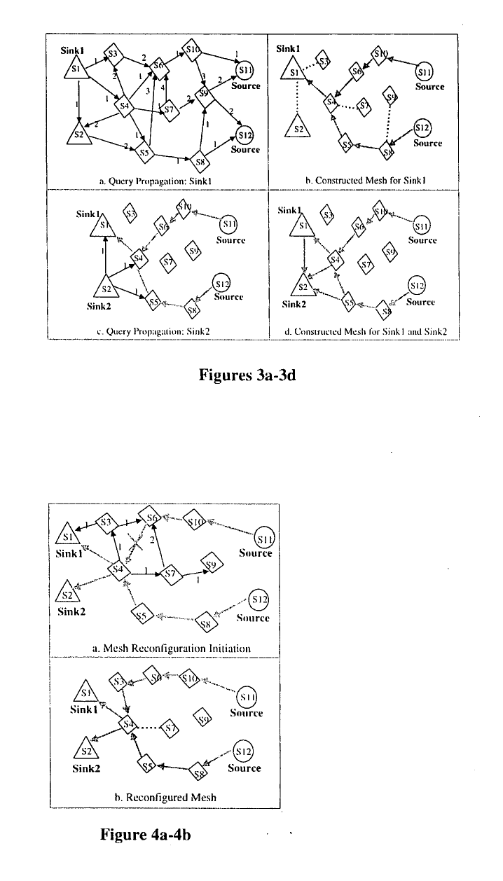

FIG. 3a-3d show the construction of a mesh initiated by Sink1. The numbers associated with the arrows indicate the “local” order in which the query (generated by Sink1) is received by a node. For example, S6 received the query first from S4, then from S3, then from S5, and then from S7. In this case, S6 creates an entry for the query (with the parent S4), propagates the query to its neighbors, and discards the query copies sent by S3, S5, and S7. In this example, Source S11 and Source S12 are sensors generating data that together satisfy the Sink1 query. FIG. 3b shows the mesh (in this case a tree) constructed by the dissemination mesh protocol. Bold lines correspond to the links that constitute the mesh that is used to disseminate data from S11 and S12 towards S1. Diamond shaped nodes that have arrows emanating from them (S10, S6, S4, S5, and S8) are Dissemination Severs that are part of the created dissemination mesh. FIG. 3c shows the propagation of the query generated by Sink2 that has similar interests as Sink1. The query is received by S1, S4 and S5; all of them terminate the query propagation because they are already members of a mesh FIG. 3b that disseminates data satisfying the query. FIG. 3d shows the mesh constructed in response to the query generated by Sink2. Note that Sink2 receives data from three nodes (S1, S4, and S5). Sink2 can enforce receiving data from S4 by sending a cancel message towards S1 and S5.

In order to maintain redundancy or restore data dissemination (e.g., in the case where all paths between a source and a sink fail), mechanisms are needed to reconfigure the mesh when some of its links/nodes fail. The invention uses an approach based on recursive local-repair of mesh failures. When a node detects a communication failure with one or more of its children, it runs the dissemination mesh protocol (described above) playing the role of a sink. The dissemination mesh protocol will construct a sub-mesh rooted/starting from the node that detected the failure(s) while satisfying the reliability/accuracy requirements of the original mesh.

Consider the following operation scenario as a continuation of the scenario shown in FIG. 3d. Assume in FIG. 4a that (i) S2 enforces data delivery via S4; thus, the links S5-S2 and S1-S2 are no longer part of the mesh; (ii) S6 moves causing the communication failure between S6 and S4; and (iii) S4 detects the failure and initiates the mesh reconfiguration (FIG. 4a) by forwarding the query with a hop limit equal to 2 to its neighbors. When S6 receives the query, it terminates the propagation of the query and finds that it has an entry for the query. Thus, S6 adds an entry for the query that corresponds to S3. When S9 receives the query, it discards the query because hop limit is equal to 1. The reconfigured mesh is shown in FIG. 4b.

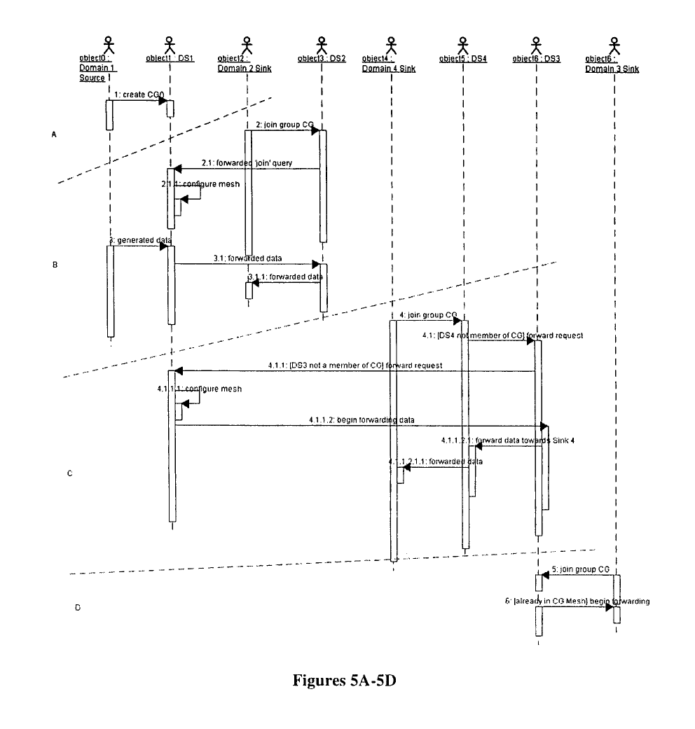

FIGS. 5A-5D illustrate another scenario that involves use of dissemination mesh concepts to support information dissemination among members of a collaboration group. In this scenario, the node that creates the collaboration group is a source and the nodes that join the group are sinks.

When a node wants to join a collaboration group, it communicates with its DS. In this application scenario, selected nodes are designated as DSs, with at least one DS per domain. The local DS checks whether it is already a member of the mesh that supports the requested collaboration group. If so, the DS is ready to forward data to the node; otherwise, it propagates the request to neighboring DSs. Eventually, the mesh supporting the requested collaboration group will be extended, using the dissemination mesh protocol, to include the DS of the node requesting to join the group.

FIGS. 5A-5D also illustrate DS interactions in supporting collaboration groups in an ad-hoc network that consists of four domains; each domain having its own DS. Border nodes in each domain notify their local DS about neighboring DSs. For example, the border node in Domain4 asks the border node in Domain3 about its DS, and reports information about DS3 to its DS4. In FIGS. 5A-5D the dissemination mesh connects sinks and sources from different domains—a source in Domain1 that streams data to sinks in Domain2, Domain3, and Domain4. In FIG. 5A, a collaboration group CG is created in Domain1. In FIG. 5B a sink in Domain2 is added to a CG via DS1 in Domain1. In FIG. 5C, Sink4 joins the group via its own DS and the DS in Domain3 performing intermediary role. In FIG. 5D a sink in Domain3 is easily added to the Mesh since DS3 already forwards CG data as an intermediary.

In MANETs, nodes (sources, sinks and DSs) may move between network domains. The challenge is to maintain continuous dissemination to these mobile nodes. The invention leverages an existing technology called Dynamic Registration and Configuration Protocol (DRCP) which configures each node in a domain (including new IP address, default router address and network services—such as DNS—addresses) and reconfigures any node that enters its domain. However, the invention requires DRCP to provide nodes with the IP address of the domain's Dissemination Server. There are two distinct types of mobility situations that the invention supports:

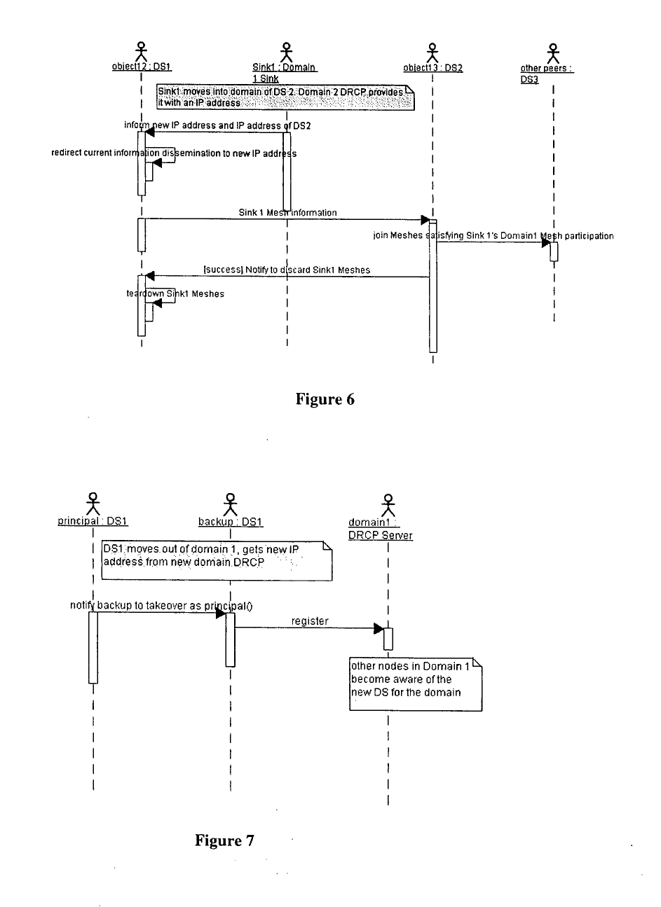

Client (Source/Sink) node mobility: When a node roams outside of its domain to a new domain, its IP address changes. The node provides the “old” domain's DS with the new IP address of the node and the IP address of the new domain's DS. Upon receipt of the new configuration information, the old domain's DS redirects the current data dissemination (i.e., that started before the node moved to the new domain) to the node using the new IP address. The old DS also provides the new domain's DS with information about the current data dissemination related to the moving node. The new domain's DS uses the dissemination mesh protocol to join the meshes that satisfy the data dissemination requirements of the node. The “old” domain's DS discards the mesh entries corresponding to the node either automatically (after a timer expires from the time the update from the node is received) or via a trigger (e.g., when the new domain's DS joins the meshes that support the current dissemination, it asks the old domain's DS to discard the corresponding entries). FIG. 6 depicts this operation.

Handling DS node mobility: When a DS roams outside of its domain to a new domain, it gets a new IP address (from DRCP). It then immediately notifies its backup DS in the “old” domain to take over as the “old” domain's DS. The backup server has a current copy of the mesh data of the moving DS. Upon receipt of the notification, the backup server registers itself with the local DRCP server that in turn advertises the “new” DS to nodes in the domain. FIG. 7 illustrates this operation.

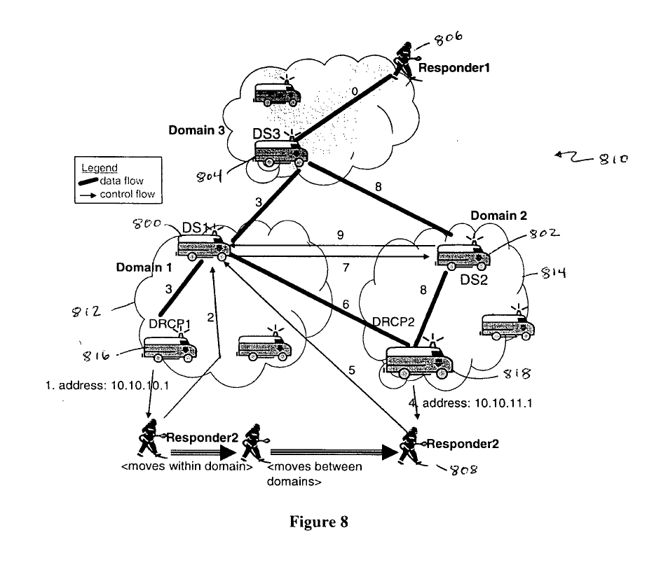

For illustrative purposes and for limiting the invention, consider the Emergency Response scenario shown in FIG. 8. In FIG. 8, Dissemination Servers 800,802,804 are mounted on emergency vehicles and users 806,808 are Responders (EMT, fire, HAZMAT) requiring a continuous streaming of information relevant to their Collaboration Group (CG) called CG1 810. The numbers on the arrows indicate the timeline order of the occurrence of the events:
(0) Responder1 806 communicates with DS3 804 to create a Collaboration task Group CG1: DS3 creates an entry for CG1.
(1) Responder2 808 enters Domain1: DRCP1 816 provides Responder2 with a new IP address and the IP address of DS1 800.
(2) Responder2 communicates with DS1 to join CG1.
(3) DS1 executes the dissemination mesh protocol to join the mesh supporting CG1.
(4) Responder2 roams outside of Domain1 812 to Domain2 814: DRCP2 818 provides Responder2 with a new IP address and the IP address of DS2 802.
(5) Responder2 communicates with DS1 to update its IP address and provides DS1 with the address of DS2.
(6) DS1 updates the entry that corresponds to Responder2 with the new address. DS1 uses the new IP address to disseminate data to Responder2.
(7) DS1 provides DS2 with the data dissemination requirements (CG1 in this example) of Responder2 together with Responder2's new IP address.
(8) DS2 executes the dissemination mesh protocol to join the mesh that supports CG1;
(9) DS2 asks DS1 to discard the entry that corresponds to Responder2 (and thus stop delivering data to Responder2); the data dissemination to and from Responder2 continues via DS2.

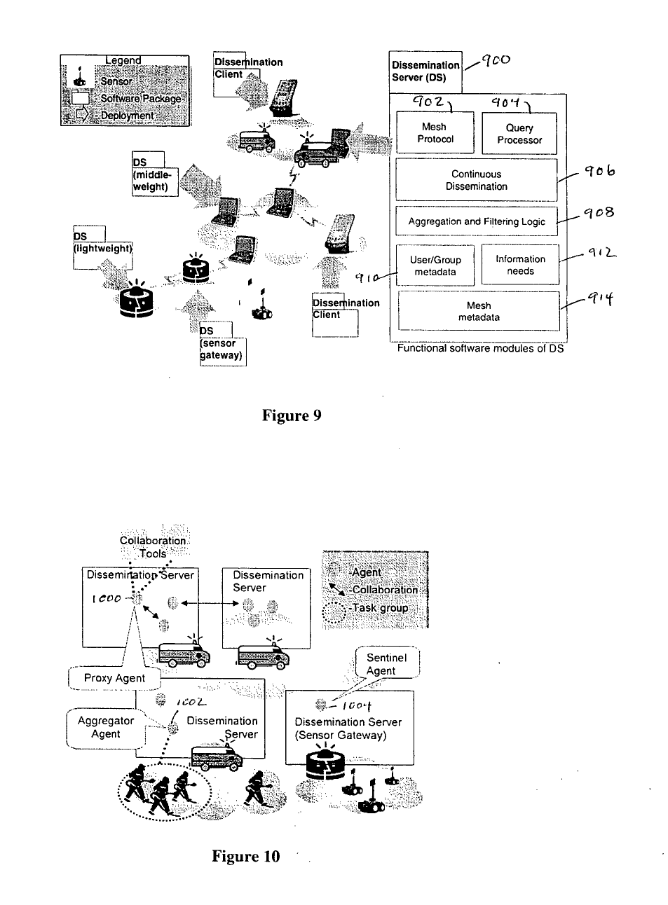

FIG. 9 illustrates a deployment and functional architecture for DSs and clients on a MANET. The Dissemination Server (DS) 900 aggregates information needs, processes queries, executes the dissemination mesh protocol, provides an interface that allows nodes to join/leave collaboration groups and to send/receive data, and provides an interface that allows continuous dissemination to nodes moving within or between domains. Main functional components of DS 900 are:

Mesh protocol 902—the functions that allow the DS to participate in the mesh protocol described in this invention, and to react to queries.

Query processing 904—the functions that allow the parsing and interpretation of queries as they are emitted into this DS (either by Users or by neighboring nodes).

Continuous Dissemination 906—the functions that allow the DS to react to changes in the MANET that threaten the continuous dissemination of information (e.g. DS moving out of sub-network).

Aggregation and Filtering 908—the functions that allow the DS to decide when and how to share existing sub-Meshes with new sinks and to filter out data from sources that is not relevant to any sinks.

User/Group metadata 910—functions that allow the storing and management of metadata pertaining to the makeup of Collaborative Groups (CG).

Information needs 912—functions that allow the storing and management of metadata pertaining to the makeup of information requirements of sinks.

Mesh metadata 914—functions that allow the storing and management of metadata pertaining to the makeup of the Dissemination Mesh itself (from the point of view of the local DS).

In FIG. 9, the arrows denote deployment of software to physical artifacts.

Three (or more) variants of DS are envisaged: (a) DS: deployed in computationally capable nodes; (b) middleweight DS: deployed in nodes with less computational power. The middleweight DS has the same functionality as DS except with a “middleweight” version of query/aggregation protocols; and (c) lightweight DS: deployed in nodes with very low computational power (such as sensors or gateways). The lightweight DS has the same functionality as DS except with a very basic version of query/aggregation protocols. Sensor gateway is a role played by a DS in which it processes queries, transforms between formats representing information needs and sensor capabilities, participates in the sensor data dissemination and Mesh construction/reconfiguration, and logs the capabilities of sensors in a logical ‘domain’. The Dissemination Client is the software ‘proxy’ to the Dissemination Servers available to the nodes in the domain. Through this client, users express information needs, preferences, join/leave requests, etc. It is also responsible to programmatically communicate with the dissemination server when its configuration information (e.g., IP addresses) changes (i.e., roaming between domains); this is needed to support continuous dissemination to mobile nodes.

Software agents are defined as: semi-autonomous software components whose goal is to facilitate system operations through reactive and proactive interactions with other agents, systems, and users. In the present invention, agents enable the creation of computational ‘stand-ins’ for various subsystems, with preprogrammed understandings of the subsystem semantics. In addition, an agent carries state and execution logic separate from the logic of the entities it proxies for. It allows the creation of agent proxies for applications, users, groups, and sensors in the ad hoc network(s). In the invention, Dissemination Servers (DS) comprise a software environment in which agents can be executed and managed¹ enabling the scenarios described in this section.

Dissemination Agents executed in the DS are provisioned and assigned into one of three possible roles. See FIG. 10:

Proxy agents 1000—are provisioned for each collaborative application—such as presence, messaging and planning tools—the proxy agents are aware of the activity within the application via an interface. The result is that a subset of application-level concepts can be injected as ‘events’ into the DS. An ontology models semantically rich representations of application level events and is used as a syntax for exchange of such events. Proxy agents may wrap up such events into the representation understood by other agents. For example, proxy agents provide unambiguous ways to express exploitable information such as: users joining a collaborative group, users signing on/off, and so on.

Aggregator agents 1002 can be provisioned for each collaborative task group (e.g. HAZMAT group, Fire dept. unit). Aggregator agents determine how best to exploit information needs common across multiple queries and groups. They represent the needs of an information sink, such as a Task group, with an understanding of the context, needs and preferences, and interact collaboratively with other Aggregators (other sinks) to determine needs overlap.

Sentinel agents 1004 (logically in Sensor Domain) are provisioned for each domain that is primarily a sensor network. Sentinel agents gather and organize sensor capabilities within a domain. While they have limited inter-agent collaboration skills, sentinels are important in the transformation of high level needs into sensor capabilities. Sentinel agents enable an aggregated view of a sensor network's capabilities, such a view is necessary for subsequent query routing.

The agent architecture employs the ‘container’ paradigm in which a main agent ‘platform’ is composed of ‘containers’ located on the same or remote host(s). Multiple agents execute in each container, each given a name relative to the container in which it executes. Within a Dissemination Server's container, agents use event passing in interaction patterns which in turn resolve local dissemination issues. To support dissemination behaviors, a set of extensible interrelated “dissemination ontologies” capture the concepts and properties from the domains of interest. Ontologies describe the relationships between concepts in sufficient detail to allow varying degrees of inference upon the concepts. OWL, a recent W3C Recommendation, is one possible syntax for encoding artifacts of interest such as:

Profiles of individual users and ad hoc Queries.

Needs of missions and task groups.

Task group membership.

Events from collaborative applications.

Semantic relationships between the above.

One example of inference performed by a DS agent is to infer a user's information needs subscription based solely on associations with other users. For example, a user entering into a collaborative group X should be assigned a needs subscription similar to the task (if any) assigned to other users in X.

Several triggers incite reactions from DS agents:
1. Query-initiated (explicit information needs subscriptions)—triggered by user-based queries for specific information on the sensor networks (e.g. number of vehicles in area X). To achieve this, the query Q is formed by a responder (sink) at a GUI or some other way (e.g., profile-based). Q's structure is associated with ontology, and then broken down into ‘root’ concepts. Aggregator Agents then determine if any current Mesh paths accommodate any parts of Q. This may require the Aggreator agent to make a non-trivial comparison between the semantics of the subscription and those of the Mesh.
2. Information Needs-initiated (implicit subscriptions)—triggered by implicit, C2, or Collaboration actions such as mission, personnel or priority changes etc. (e.g. HAZMAT Team Y is assigned to Task X). Processing occurs the same as in query-initiated behaviors.
3. Capability-initiated—triggered by a sensor's addition or removal to or from the sensor network (e.g. a new sensor added to network C). New sensor capabilities—such as sensor type, and output types—are aggregated by Dissemination Servers. The capabilities are encoded using the OWL ontology. Later, Dissemination Servers use these capabilities to determine if any sensor in the domain is an appropriate source for a given query or information-need.
4. Application events initiated—as users perform actions in applications that are proxied by DS agents various reactions may need to occur. For example, subscription profiles may need to be changed as users enter and leave groups, and, as a result, the Mesh may need reconfigurations accordingly.

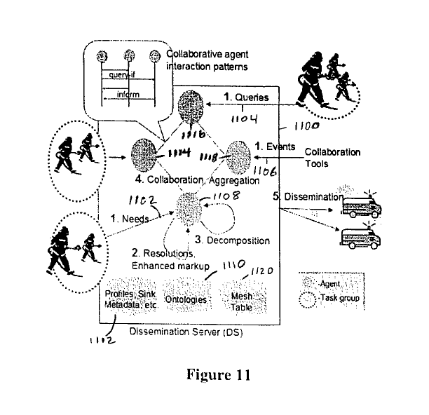

FIG. 11 shows that an important part of responding to explicit queries or implicit information-needs from information sinks, e.g., Users, groups, or even other Servers, is the agent-based collaboration and aggregation. The agents within a DS 1100 have the following characteristics: (1) Represent one or more users—i.e. a Collaborative Task groups, (2) Encode the changing information needs of the user/group so that at any time the agent understands what is required, (3) Map sinks to the paths that go through the DS and maintain path metadata (relations to sinks), and (4) Collaborate via interaction (message-passing) patterns.

DS Agent interaction patterns are derived from the Foundation for Intelligent Physical Agents (FIPA) protocols. An elegant FIPA pattern with which DS agents will message-pass is called query-If and constrains agent interactions to the following: Sender sends a query message to a set of receivers (the query payload is arbitrary). Receivers check feasibility and respond by either informing an OK (and a payload) or DENY. The sender then gathers the responses; in the case of non-unanimous responses from peers, it may alter the query message and re-send it to the receivers. FIG. 11 and the following description describe the internal agent-based operations of a single DS as it reacts to information needs, susbscriptions, and queries.
1. Information needs 1102, queries 1104 or events 1106 are formulated by dynamic Task groups or their collaborative applications. They enter their local DS (profile-based implicit input is also possible). For example, an information need, IN-1, might be to get motion and radiation levels in an area Z.
2. As the information need enters the DS they are relayed to the agent, say B 1108, which currently represents the collaborative task group from which the need emerged. B stewards metadata about the Sink's context—for example, the currently assigned mission. By referring to the ontologies 1110 and metadata 1112. B supplements IN-1 by inferring any additional needs. For example, B may understand that area Z contains areas X and Y, and that members of the Task Group should have an operational picture that includes imagery from infra-red sensors (warranted by the group's mission). The resulting information need may now include additional inferred concepts.
3. The information need is decomposed into its fundamental parts; that is, parts that might originate from independent sources. For example, after the markup of IN-1, its fundamental parts will include: radiation, motion, and infrared sensed objects, area X and area Y.
4. The agents in the Dissemination Server now collaborate to determine which, if any, local DS agents have previously propagated a request for any of the parts of IN-1. In our example, agent B queries every other agent 1114,1116,1118 in the DS. Each agent then checks its metadata to determine if a path already exists for the information needs component, and then responds to the sender with an informative message.
5. The results of collaboration will be that either the new information need is aggregated with an existing Mesh path in mesh table 1120, or it cannot be currently satisfied and so is propagated to neighbor DS.

Ongoing performance evaluations of the JADE agent platform to analyze its ability to satisfy our requirements upon 800 MHz Pentinum laptops show that a JADE-based Dissemination Server should be able to support around 300 requests per second.

While there has been described and illustrated an architecture for multi-domain wireless mobile ad hoc network information dissemination and several modifications and variations thereof, it will be apparent to those skilled in the art that further modifications and variations are possible without deviating form the teachings and broad principles of the invention which shall be limited solely by the scope of the claims appended hereto.

What is claimed is:

1. An architecture for information management and delivery in peer-to-peer mobile ad hoc networks comprising:
at least one source node;
at least one sink node;
at least one dissemination server (DS); and
intelligent agents which configure source nodes, sink nodes, and DSs in a domain and reconfigures any source node, sink node and DS entering the domain so that information traveling from a source node to a sink node traversing the DS continues towards the sink node as a source node, sink node and DS enter and exit domains.

2. A method for managing and delivering information in peer-to-peer mobile ad hoc networks comprising the steps of:
configuring each source node, sink node and dissemination server (DS) in a first domain;
reconfiguring any source node, sink node and DS entering the first domain or leaving the first domain to a second domain; and
forwarding information from a DS in the first domain toward a reconfigured sink node in the second domain.
